(19) United States
(12) Patent Application Publication
(10) Pub. No.: US 2003/0054077 A1
(43) Pub. Date: Mar. 20, 2003

(54) Clarification of beer fermentation

(75) Inventors: Yoshihisa Ishiwata, Kanagawa (JP); Takeshi Ohnogi, Okayama-Ken (JP); Hiroyasu Nishida, Kitakyushu-Shi (JP); Mitsuru Nakai, Fukuoka-Ken (JP); Akihiko Okada, Kanagawa (JP)

Correspondence Address: FOLEY AND LARDNER, SUITE 500, 3000 K STREET NW, WASHINGTON, DC, 20007, US

(73) Assignee: KIRIN BEER KABUSHIKI KAISHA

(21) Appl. No.: 10/150,095

(22) Filed: May 20, 2002

Related U.S. Application Data
(63) Continuation of application No. 09/435,626, filed on Nov. 8, 1999.
Application No. 09/435,626 is a continuation of application No. 08/775,035, filed on Dec. 30, 1996, now abandoned.

(30) Foreign Application Priority Data
Dec. 28, 1995 (JP) 342584/1995
Dec. 28, 1995 (JP) 342589/1995

(51) Int. Cl. C12C 1/00

(52) U.S. Cl. 426/330.4

(57) ABSTRACT

Finings comprising a silica sol which is added to beer during the lagering process have at least two peaks in the particle size distribution curve of the colloidal particles of said silica sol, of which particle diameters Dₚ and D_{q} are in the range of 20 nm Dₚ 40 nm and 150 nm D_{q} 600 nm, respectively.

Beer is clarified with use of the finings. The first running of beer output process is treated by adding the silica sol in an amount of 50-500 ppm based on dry materials to the first running of beer and left standing for 2-15 hours, and the supernatant is filtrated to obtain clear beer.

### BACKGROUND OF THE INVENTION

The present invention relates to the clarification technique of beer during the lagering process after the fermentation process.

Furthermore, the present invention relates to a process for treating the first running of beer from a fermentation tank after the lagering process to recover the beer thereby improving the yield of the beer.

Beer is produced by the two processes of the fermentation process and the lagering process. The beer after the fermentation process, the so-called green beer, is subjected to the lagering process at a lower temperature than the fermentation process after the filtration of yeast used (sherry yeast or immobilized yeast) or without removal of the yeast. The beer after the lagering process is then withdrawn from the lagering tank bottom and subjected to the filtration process. The lagering process is continued ordinarily for about one month at a temperature of from −1 to 6 [symbol] C.

The beer to be subjected to the lagering process after the fermentation process contains turbid components such as proteins, which are finally removed by the filtration after the lagering process to give a product beer. These turbid components suspend in a beer at the end of the fermentation and cause the clogging of a filter to lower its filterability and often to result in the difficulty of filtration.

In order to avoid such problems during the filtration, the filterability has been conventionally improved by using larger amount of diatomaceous earth as a body feed. At the same time, silica sol has also been added during the lagering process as a countermeasure to carry out “clarification” for preliminarily removing the turbid components and thus lowering the load on filtration.

The clarification is called “the flocculation”, which has been conventionally carried out in the production of general liquid fermented foods. The methods of the clarification have been proposed for example in Japanese Patent Laid-Open Publication Nos. 27376/1985 and 216179/1991. In the latter publication, it has been proposed to use a silica sol comprising colloidal particles and having at least two different peaks in the particle size distribution curve as an adhesive flocculant for a variety of fermented liquid foods.

However, the most efficient method of clarification (flocculation) can be varied depending on the kind of fermented foods due to the possible distinctions of turbid components. By such a reason, the clarification methods for particular uses such as the clarification method for rice wine (Japanese Patent Laid-Open Publication No. 71883/1983) and the clarification method for mirin (Japanese Patent Laid-Open Publication No. 268678/1990) have been proposed as well.

Particularly, in the case of the clarification during the lagering process in the production of beer, a small amount of yeast which serves for lagering needs to remain still during the lagering process even if the yeast used has been substantially removed after the fermentation process. Thus, the clarification should be carried out by the method which will not affect the physiology of the yeast, and finings which work well on the production of a food is not necessarily used successfully for the production of beer. This is described for example in Japanese Patent Laid-Open Publication No. 193685/1983.

On the other hand, beer which has been passed through the fermentation and lagering processes is withdrawn from a lagering tank and subjected to the filtration process. The process for withdrawing the beer from the lagering tank is called “beer output process”.

During the lagering period, solid components such as yeast and proteins suspending in the beer after the fermentation process will precipitate. During the beer output process, it is preferred to avoid the contamination of the beer with these sediment in order to lower the load in the filtration process.

Thus, it is usually carried out first to remove sediment from the tank bottom, then to transfer into another tank the “first running” which is first taken out and has a high concentration of the sediment, and to transfer clear beer which follows the first running directly to the filtration process. The first running is produced in an amount of about 0.5-1.5 kiloliters in an lagering tank having a volume of 100 kiloliters.

In the existing circumstances, the first running transferred into another tank is left standing to precipitate the suspended materials, and the supernatant is filtered to recover beer. The beer thus recovered is returned to the same beer, particularly the beer in the lagering process, so that the first running treating process is usually carried out in parallel with the filtration process.

However, if the treatment of the first running is carried out for an unduly long time, the filtration of the supernatant as the main fraction is finished during the treatment of the first running, and tanks for storing a large amount of the filtrated beer are required until the first running has been treated. On the other hand, if the treatment of the first running is carried out only for a short time in order to avoid the above described problem, the first running is clarified only insufficiently.

### SUMMARY OF THE INVENTION

The finings according to the present invention are finings comprising a silica sol which is added to a beer during the lagering process, and the particle size distribution curve of the colloidal particles of silica sol may have at least two different peaks, of which particle diameters Dₚ and D_{q} are in the range of 20 nm Dₚ 40 nm and 150 nm D_{q} 600 nm, respectively.

In addition, the process for clarifying beer according to the present invention comprises adding finings comprising a silica sol in beer during the lagering process, and the particle size distribution curve of the colloidal particles of silica sol may have at least two different peaks, of which particle diameters Dₚ and D_{q} are in the range of 20 nm Dₚ 40 nm and 150 nm D_{q} 600 nm, respectively. Also, the fining may be added in an amount of 20-500 ppm based on the dry materials and contacted with the beer.

Furthermore, in the process for treating the first running of the beer output process according to the present invention, it is also possible to add for example a silica sol in an amount of 50-500 ppm based on the dry materials to the first running to leave the mixture standing for 2-15 hours and to filtrate the supernatant to obtain clear beer.

If the fining for beer according to the present invention is used for the clarification of beer, large flocculates are formed in a short time without impairing the properties of beer such as flavor and foam stability thus resulting in the rapid flocculation and small volumes of the sediment. In addition, no influence on the physiology of the yeast which affects significantly the quality of beer is observed by the use of the finings It is also possible to reduce the amount of diatomaceous earth used as the body feed aid, which is advantageous environmentally and economically.

According to the process for treating the first running of the beer output process according to the present invention, it is possible to remove rapidly suspended matters in the first running during the beer output process and to recover economically and efficiently the beer.

### PREFERRED EMBODIMENT OF THE INVENTION

### Finings for Beer and Process for Clarifying Beer

Japanese Patent Laid-Open Publication No. 216179/1991 described above discloses the use of silica sol having at least two different peaks in the particle size distribution curve as a adhesive flocculant of a variety of fermented liquid foods. It has been described in the aforementioned publication that when the silica sol used has at least two particle size distributions of colloidal particles of silica sol, the smallest peak diameter Dₚ is preferably in the range of 3 nm Dₚ 30 nm and the precipitating rate is undesirably lowered at Dₚ larger than the above described range.

However, the present inventors have found as a result of examination that some silica sols are superior to the silica sol according to the above described invention for the clarification of beer. That is, it has been found that when the particle size distribution curve of colloidal particles has at least two different peaks, of which particle diameters are represented as Dₚ and D_{q}, clarification becomes more effective, in other words, the filterability of beer is improved more extensively without impairing the properties of beer by using a silica sol having the peak particle diameters, for example, in the range of 20 nm Dₚ 40 nm and 150 nm D_{q} 600 nm, respectively. The present invention is based on the findings.

The silica sol according to the present invention has at least two peaks in the particle size distribution curve of colloidal particles, among which the silica colloidal particles giving the peak at the side of the smaller particle diameters exhibit a strong effect of floculating turbid proteins, while the silica colloidal particles giving the peak at the side of the larger particle diameters probably serve for aggregating further the turbid proteins floculated. It is thus believed that large aggregates are formed in a short time, so that the precipitating rate is increased and the volume of the sediment is reduced. Proteins causing turbidity are different from each fermented liquid foods, and the operation condition is appreciated most suitable at the aforementioned particle size distribution in the case of beer. In fact, Japanese Patent Laid-Open Publication No. 216179/1991 discloses nothing about beer as an object of examples, and the particle diameter giving the peak at the larger particle side is at most 45 nm, which is considerably smaller than the particle diameter giving the peak at the larger particle side as the requirement of the present invention.

Furthermore, finings containing the silica sol of the present invention are characterized by not affecting the physiology of yeast which influences significantly the quality of beer. Thus, the quality of beer obtained is substantially the same as beer produced by the conventional method without use of the finings according to the present invention.

The colloidal particles of the present invention has specific particle size distribution as described above. Dₚ can be in the range of 20 nm Dₚ 40 nm. If Dₚ is less than 20 nm, the colloidal particles has a strong power of floculating protein turbid materials but the floculates are small in size and hardly cause the reaction with large silica particles (D_{q}), so that flocculates tend to remain in the beer. If Dₚ is more than 40 nm, the colloidal particles have a small power of aggregating flocculates and hardly form complete aggregates, so that the colloidal particles tend to have a little clarification effect.

On the other hand, D_{q} can be in the range of 150 nm D_{q} 600 nm. If D_{q} is less than 150 nm, final aggregates formed are small in size, so that the precipitating rate tends to be slow. If D_{q} is more than 600 nm, the silica particles have an unduly large dead weight and precipitate before they are reacted with the protein turbid materials, so that they hardly form large floculates and thus the precipitating rate tends to be slow. However, the values of Dₚ and D_{q} are not strictly limited within the ranges described above.

In this connection, the particle size according to the present invention means the sphere reduced particle diameter. It represents the diameter of a sphere having the same volume as the particle which is not always spherical. The methods for measuring the diameter of such particles include a variety of methods such as the dynamic light scattering method. Specifically, the diameter of the particles is measured with NICOMP Model 370 Submicron Particle Sizer (Pacific Scientific, Santa Barbara, Calif., USA).

The silica sol used in the present invention may be prepared by combining a plurality, preferably two kinds of silica sols which are conventionally used as finings and comprise colloidal particles having different particle size distributions from each other. In this case, the particle size of the colloidal particles of the silica sol combined are optional, and any silica sols may be combined, provided that the silica sol obtained by the combination of silica sols has the particle size distribution of the colloidal particles as described above.

While the finings according to the present invention comprises the silica sol comprising the colloidal particles having the specific particle size distribution curve described above, it may contain any additives as far as the effect of the present invention will not impaired. For instance, the silica sol, which contains silica particles having the particle diameter exceeding 70 nm, it may be stabilized by adding agents such as a stabilizer.

The clarification of beer may be carried out in any steps before the filtration process during the beer producing processes. The production of beer generally comprises the two processes of the fermentation process and the lagering process, Thus, at the optional step during the lagering process, the finings according to the present invention may be added, and filtration may be carried out as usual. However, in consideration of the easiness of operations and the effects, it is desirable to add the finings during the transfer of the beer from the fermentation tank to the lagering tank and to carry out the lagering process as usual.

The effect of the present invention appears by adding the finings of the present invention in an amount of about 20 parts by weight or more to 1,000,000 parts by weight of the beer (about 20 ppm or more) in the lagering process. However, if the finings are added in an amount of about 500 ppm or more, it is not desirable from the standpoint of economy to add the finings in an amount of about 500 ppm or more because of disadvantages such as the loss of beer due to the incorporation of beer into the sediments or the high cost of the finings. However, the amount of the finings added is not strictly limited to these values. It is most preferred in consideration of both its effect and economy to add the finings in an amount of 30- 200 ppm, but it is not limited thereto.

The contact time of the finings according to the present invention with the beer for clarification depends on the heights of a lagering tank, and generally about three days with a tank having a height of about 14 m. Thus, it is one of the preferred embodiments of the clarification according to the present invention to add finings to the beer during the transfer of it from the fermentation tank to the lagering tank and to contact the finings with the beer throughout the whole period of the lagering process.

After clarification according to the present invention, beer is filtrated if neccessarily with a body feed such as diatomaceous earth. In this case, the whole beer containing the sediment may be filtrated or only the supernatant may be filtrated. The latter is preferred from the standpoint of lowering the load of filtration.

When the finings according to the present invention is used, it is possible to carry out filtration as usual with diatomaceous earth as the body feed in an amount of 50% or less of that usually employed. The diatomaceous earth used as the body feed is disposed as an industrial waste after use, and thus the reduction of the amount of the diatomaceous earth used is very preferred from the standpoint of both social environmental protection or economy.

### Process for Treating the First Running of Beer Output Process

On the other hand, in the process for treating the first running of beer output process of the present invention, that is the fraction discharged first together with the sediments after the lagering process from the lagering tank, the silica sol is added to the first running of beer for clarification. As the silica sol used in this treatment, any silica sols which will not impair the quality of beer upon its addition during the production of beer can be used. Specifically, the silica sol comprising silica particles having a particle diameter generally in the range of 3- 600 nm, preferably 20-600 nm, is used. Silica sols which can be used as the finings have been described in Japanese Patent Publication Nos. 33351/1984 and 16187/1985, and Japanese Patent Laid-Open Publication No. 216179/1991.

Precipitations can be formed rapidly by using the colloid particles having at least two peaks in the particle size distribution curve as described in the paragraph of the process for clarifying beer as the silica sol. It is believed that the silica colloidal particles which afford a peak in the smaller particle diameter side has a strong effect of floculating protein turbid materials, and the silica colloidal particles which afford a peak in the larger particle diameter side work for further aggregating protein turbid materials floculated.

Among such silica sols are preferred the one which satisfies at least one of the following equations,

Dₓ 1.3 D₁

wherein x denotes an integer of 2-n, and Dₗ represents the particle diameter of the colloidal particles having at least two peaks in the particle size distribution curve and affording the peak at the smallest particle diameter side, and D₂, D₃, . . . Dₙ, represent the particle dameters affording the other peaks.

Furthermore, when the particle size distribution curve of colloidal particles may has at least two different peaks, of which particle diameters are represented as Dₚ and D_{q}, it is possible to set these peak particle diameters in the range of 20 nm Dₚ 40 nm and 150 nm D_{q} 600 nm, respectively.

In this connection, the particle diameter herein means the sphere reduced particle diameter which is the same as that described in the process for clarifying beer.

In the process for treating the first running of the beer output process according to the present invention, the aforementioned silica sol is added to the first running during the beer output process. In the clarification of the first running at the beer output process, the beer has a very high concentration of suspended matters and is subjected to beer output process after the optimal lagering period, so that the shorter the period of the clarification, the more preferred the clarification. In consideration of these points, the silica sol is preferably added in a larger amount, particularly about 50 ppm or more on the basis of dry the materials. However, it should be avoided to add an unduly large amount of the silica sol. The addition of the silica sol in an amount of about 500 ppm or more is not economically preferred due to the cost of the silica sol and the loss of beer incorporated into the sediment. However, the amount of the silica sol added is not limited strictly to these values. Most preferably, the silica sol having the strongest effect is added in an amount of 100-300 ppm without limitation thereto.

After the addition of silica sol, the beer is preferably left standing for a short time, generally for 2-15 hours. Particularly from the standpoint of economy, it is preferred to let the beer stand for about 3-8 hours without limitation thereto.

Beer recovered from the first running of beer output process is usually returned to the beer, particularly the one after the lagering process, from which the first running has been fractionated, and thus it is preferred to let the the beer having the silica sol added thereto stand at the same temperature as that on beer output process so that the beer is lagered to the same level under the same condition as the main stream from which the first running has been taken out.

Among the first running having the sediment therefrom, only the supernatant is introduced into a beer output process line through a liquid removing tube at the side of the tank, and then transferred to the filtration process to mix with the beer of the main stream. The beer filtrated after treating the first running of beer output process according to the present invention is substantially equal to the conventional beer in the properties of beer such as flavor and foam stability.

The present invention is described further specifically with reference to the following examples.

### EXAMPLES

### Preparation Example 1

Silica sol for clarification (L) was prepared by mixing 23 g of 40% silica sol (CATALOID SI-40, average particle diameter 18 nm, Catalysts & Chemicals Industries CO., Ltd. (Japan)) and 35 g of a 17% silica suspension of silica colloidal particles (SPHERICA SLURRY 160, average particle diameter 160 nm, Catalysts & Chemicals Industries CO., Ltd.). When the particle size distribution of the silica sol for clarification (L) was measured with a Submicron Particle Sizer NICOP Model 370 (Pacific Scienctific), the particle diameter distribution curve showed two peaks with the peak in the smaller particle diameter side (Dₚ) at 23 nm and the peak in the larger particle diameter side (D_{q}) at 190 nm.

### Preparation Example 2

Silica sol for clarification (M) was prepared by mixing 25 g of 48% silica sol (CATALOID SI-50, average particle diameter 25 nm, Catalysts & Chemicals Industries CO., Ltd.) and 50 g of a 17% silica suspension of silica colloidal particles (SPHERICA SLURRY 120, average particle diameter 120 nm, Catalysts & Chemicals Industries CO., Ltd.). When the particle size distribution of the silica sol for clarification (M) was measured in the same manner as in Preparation Example 1, the particle size distribution curve showed two peaks with the peak in the smaller particle diameter side (Dₚ) at 30 nm and the peak in the larger particle diameter side (D_{q}) at 155 nm.

### Preparation Example 3

Silica sol for clarification (N) was prepared by mixing 50 g of 30% silica sol (FC-200 SUPER, average particle diameter 21 nm, Catalysts & Chemicals Industries CO., Ltd.) and 50 g of a 18% silica suspension of silica colloidal particles (SPHERICA SLURRY 160, average particle diameter 165 nm, Catalysts & Chemicals Industries CO., Ltd.) When the particle size distribution of the silica sol for clarification (M) was measured in the same manner as in Preparation Example 1, the particle size distribution curve showed two peaks with the peak in the smaller particle diameter side (Dₚ) at 31 nm and the peak in the larger particle diameter side (D_{q}) at 196 nm.

### Preparation Example 4

Silica sol for clarification (O) was prepared by mixing 30 g of 30% silica sol (FC-200 SUPER, average particle diameter 19 nm, Catalysts & Chemicals Industries CO., Ltd.) and 50 g of a 18% silica suspension of silica colloidal particles (SPHERICA SLURRY 550, average particle diameter 550 nm, Catalysts & Chemicals Industries CO., Ltd.). When the particle size distribution of the silica sol for clarification (M) was measured in the same manner as in Preparation Example 1, the particle size distribution curve showed two peaks with the peak in the smaller particle diameter side (Dₚ) at 16 nm and the peak in the larger particle diameter side (D_{q}) at 588 nm.

### Examples 1-4 and Comparative Examples 1-2

Each of the silica sols prepared in Preparation Examples 1-4 was added with stirring at 100 rpm in an amount listed in Table 1 as finings to beer lagered as usual, and the mixture was left standing at the same temperature for four days to evaluate the filterability of the supernatant.

The filterability was evaluated by filtrating the supernatant through a membrane filter having a pore size of 0.45 μm under a pressure of 1 kg/cm² and calculating Vmax by the Esser method (Esser, K. D.; Monatsschrift fuer Brauerei, 25 (6), 145 (1972)). The results are shown in Table 1.

TABLE 1

| | | | | Added | |
|---|---|---|---|---|---|
| | Silica sol | Dₚ | D_{q} | amount | Vmax |
| Example | used | (nm) | (nm) | (ppm) | (hl/m²) |
| Example 1 | L | 23 | 190 | 180 | 5.0 |
| Example 2 | M | 30 | 155 | 180 | 3.5 |
| Example 3 | N | 31 | 196 | 180 | 4.2 |
| Example 4 | O | 27 | 588 | 180 | 3.4 |
| Comp. Ex. 1 | not used | — | — | — | 0.9 |
| Comp. Ex. 2 | FC-200 Super | 10 | 40 | 180 | 2.6 |
| | (Commercial | | | | |
| | product) | | | | |

While the effect of the clarification by using a silica sol is proved from the comparison of Comparative Examples 1 and 2, it is turned out that Examples 1-4 in which the finings according to the present invention exhibit by far the superior clarification effect to that in Comparative Example 2 in which the finings other than those of the present invention. In this connection, the silica sol used in Comparative Example 2 is included in Japanese Patent Laid-Open Publication No. 216179/1991 described above. It is confirmed from these results that the finings with use of the specific silica sol according to the present invention exhibits distinguishedly the effect when applied to the production of beer.

### Example 5 and Comparative Examples 3-4

The fining according to the present invention (containing silica sols having the particle diameters Dₚ=33 nm, D_{q}=165 nm) was added in an amount of 180 ppm based on the dry materials to a green beer having finished the fermentation in a pilot plant having a volume of 2 kiloliters during transferring it from the fermentation tank to a lagering tank and mixed well with the beer, and the mixture was lagered in the conventional method in the lagering tank.

In Comparative Examples, no silica sols were added to the green beer.

After lagering, the beer was filtrated through a diatomaceous earth filter having a filtration area of 0.2 m² and a filtration rate of 500 liter/m²/hour at a temperature of 2 [symbol] C. for 4 hours. Filtration was carried out with varying amounts of a body feed (diatomaceous earth) in the diatomaceous earth filter. The filterabilities are shown in Table 2. The amount of the body feed of filter aids used is represented as a percentage to the amount usually used as 100%.

TABLE 2

| | Amount | | Increase of | |
|---|---|---|---|---|
| | of body | Vmax before | differential | |
| | feed | filtration | pressure | Turbidity of |
| | (%) | (hl/m²) | (kg/cm²/hr) | filtrate (ppm) |
| Example 5 | 35 | 4.3 | 0.08 | 0.2 |
| Comp. Ex. 3 | 35 | 1.4 | 0.85 | 0.3 |
| Comp. Ex. 4 | 100 | 1.4 | 0.10 | 0.2 |

When the finings of the present invention were not added, the differential pressure unduly increased with use of 35% of a body feed. When the finings of the present invention were added in Example 5, filtration was feasible substantially in the same manner as the usual filtration even if the amount of the body feed was descreased.

Furthermore, the beer produced in Example 5 was substantially equal to the one produced in Comparative Example 3 as the result of comparison of these beers in the total amount of nitrogen, the total amount of polyphenols, color, the amount of head foaming, head retention time, turbidity of bottled beer, turbidity after storage at 50 [symbol] C. for 2 weeks, turbidity at low temperature after storage at 50 [symbol] C. for 2 weeks, SiO₂ content, and flavor.

### Example 6 and Comparative Examples 5-7

Test was carried out in the same manner as Example 5 except that the silica sol as finings was added in an amount of 36 ppm. Comparative Examples 5 and 6 were carried out with FC-200 Super in the same amount as Example 6 on the basis of dry materials, and Comparative Example 7 was carried out without addition of the silica sol.

TABLE 3

| | Amount | | Increase of | |
|---|---|---|---|---|
| | of body | Vmax before | differential | |
| | feed | filtration | pressure | Turbidity of |
| | (%) | (hl/m²) | (kg/cm²/hr) | filtrate (ppm) |
| Example 6 | 60 | 2.1 | 0.12 | 0.2 |
| Comp. Ex. 5 | 60 | 1.0 | 0.22 | 0.6 |
| Comp. Ex. 6 | 100 | 1.0 | 0.14 | 0.3 |
| Comp. Ex. 7 | 100 | 1.2 | 0.12 | 0.2 |

In Example 6, it was possible to carry out filtration as usual even if the body feed of filter aid was decreased by 40% in spite of the reduced amount of the silica sol as the finings to 36 ppm. On the other hand, in Comparative Example 5, although the silica sol was added, the effect of it remained little.

Furthermore, the beer produced in Example 6 was substantially equal to the one produced in Comparative Example 7 as the result of comparison of these beers in the total amount of nitrogen, the total amount of polyphenols, colors, the amount of head foaming, head retention time, turbidity of bottled beer, turbidity after storage at 50 [symbol] C. for 2 weeks, turbidity at low temperature after storage at 50 [symbol] C. for 2 weeks, SiO₂ content, and flavor.

### Preparation Example 4

Silica sol for clarification was prepared by mixing 40 g of 30% silica sol (FC-200 SUPER, average particle diameter 20 nm, Catalysts & Chemicals Industries CO., Ltd.), 8 g of 40% silica sol (CATALOID SI-80P, Catalysts & Chemicals Industries CO., Ltd.) and 17 g of a 18% silica suspension of silica colloidal particles (SPHERICA SLURRY 160, average particle diameter 150 nm, Catalysts & Chemicals Industries CO., Ltd.). When the particle size distribution of the silica sol for clarification was measured with a Submicron Particle Sizer NICOP Model 370 (Pacific Scienctific), the particle size distribution curve showed two peaks with the peak in the smaller particle diameter side (Dₚ) at 33 nm and the peak in the larger particle diameter side (D_{q}) at 165 nm.

### Example 7

When beer brewed as usual in a pilot plant having a volume of 2 kiloliters was subjected to beer output process, a silica sol as described in Table 4 was added to 3 liters of the first running to mix sufficiently with the beer before storing in a cylindrical container at 0 [symbol] C.

After 10 hours, 2.8 liters of the supernatant was taken out to evaluate the filterability. The filterability was evaluated by filtraing the supernatant through a membrane filter having a pore size of 0.45 μm under a pressure of 1 kg/cm² and calculating Vmax by the Esser method (Esser, K. D.; Monatsschrift fuer Brauerei, 25 (6), 145 (1972)). The results are shown in Table 4.

TABLE 4

| | Added amount | Vmax |
|---|---|---|
| Silica sol | (ppm) | (hl/m²) |
| Silica sol in Preparation Example 4 | 50 | 1.3 |
| | 100 | 1.7 |
| | 300 | 1.8 |
| | 500 | 1.8 |
| FC-200 Super*¹ | 100 | 1.5 |
| STABISOL*² | 100 | 1.5 |
| No additive, first running beer | 0 | 0.6 |
| No additive, output process beer after removing | 0 | 1.7 |
| the first running | | |

*¹Silica sol, Catalysts & Chemicals Industries CO., Ltd.;
*²Silica sol, Stabifix Brauerei-Technik (Muenchen, Germany)

It was possible to get the Vmax equal to that of the output process beer, which is taken out after the first running beer, by adding the silica sol to the first running beer. The output process beer is directly subjected to the filtration process, so it is understood that the first running beer treated with the silica sol can be filtered as well.

In addition, in Example 7, the beer after the addition of the silica sol was left standing for 10 hours. This time substantially corresponds to the time required for the filtration of the rough beer in a tank in the conventional production of beer. It is thus possible to finish the treatment of the first running during the filtration of the output process beer and to return the first running treated to the rough beer of the same lot.

The entire disclosure of Japanese Patent Application No. 342584/1995 filed on Dec. 28, 1995 and Japanese Patent Application No. 342589/1995 fled on Dec. 28, 1995, including specification, drawings and claims are herein incorporated by reference in its entirety.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. Finings comprising a silica sol which is added to beer during the lagering process, in which the particle size distribution curve of colloidal particles of said silica sol has at least two different peaks, of which particle diameters Dₚ and D_{q} are in the range of 20 nm Dₚ 40 nm and 150 nm D_{q} 600 nm, respectively.

2. Finings according to claim 1, wherein the particle size distribution curve of colloidal particles of said silica sol has two different peaks.

3. A process for clarifying beer comprising adding finings comprising a silica sol in beer during the lagering process, in which the particle size distribution curve of the colloidal particles of silica sol has at least two different peaks, of which particle diameters Dₚ and D_{q} are in the range of 20 nm Dₚ 40 nm and 150 nm D_{q} 600 nm, respectively, and the finings are added to the beer in an amount of 20-500 ppm based on the dry materials and contacted therewith.

4. A process for treating the first running of beer output process, in which a silica sol is added to the first running of beer in an amount of 50-500 ppm based on the dry materials, to leave the mixture standing and to filter the supernatant to obtain clear beer.

5. A process of the treatment according to claim 4, wherein the particle size distribution curve of the colloidal particles of silica sol has at least two different peaks, and satisfies the following equation,
Dₓ 1.3 Dₗ
wherein x denotes an integer of 2- n, and Dₗ represents the particle diameter of the colloidal particles having at least two peaks in the particle size distribution curve and affording the peak at the smallest particle diameter, and D₂, D₃, . . . Dₙ represent the particle dameters affording the other peaks, respectively.

6. A process according to claim 4, wherein when the particle size distribution curve of colloidal particles has at least two different peaks, of which particle diameters are represented as Dₚ and D_{q} being in the range of 20 nm Dₚ 40 nm and 150 nm D_{q} 600 nm, respectively.

7. A process for treating the first running of beer output process, in which in claim 4, the first running of beer is fractionated and left standing for 2-15 hours after the addition of silica sol in an amount of 50-500 ppm based on dry materials, and the supernatant is filtrated to recover clear beer, which is then returned to the beer of the same lot.
